(19) United States
(12) Patent Application Publication
(10) Pub. No.: US 2009/0196541 A1
(43) Pub. Date: Aug. 6, 2009

(54) FLOW BEARING FOR HIGH PRESSURE APPLICATIONS

(76) Inventor: Orren S. Johnson, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/363,428

(22) Filed: Jan. 30, 2009

(30) Foreign Application Priority Data
Jan. 31, 2008 (CA) 2622362

(51) Int. Cl. F16C 17/02

(52) U.S. Cl. 384/114

(57) ABSTRACT

A flow bearing includes a first tubular body and a second tubular body. The first tubular body has a first outer surface and a first inner surface defining a first bore. A first bearing surface is positioned on the first inner surface. The second tubular body has a second outer surface and a second inner surface defining a second bore. A second bearing surface is positioned on the second inner surface. The second tubular body is concentrically disposed within the first bore of the first tubular body, with the first inner surface facing the second outer surface. The first bearing surface and the second bearing surface are engaged in close fitting relation and define a mud lubricated flow gap. A metering valve is positioned one of upstream or downstream of the flow gap to meter flow through the flow gap.

### FIELD

The present invention relates to flow bearing used in downhole oil drilling tools.

### BACKGROUND

In a downhole drilling motor with a flow bearing most of the drilling fluid flows through the interior of the drilling motor and some of the drilling fluid is diverted through the flow bearing to the annulus of the well bore. The amount of mud flow that is diverted through the flow bearing increases with pressure. Problems are currently being experienced in downhole drilling motor assemblies having components that use flow bearings. When operated under increased pressure, there is sometimes excessive flow through the flow bearing which can leave insufficient drilling fluid flow through the downhole drilling motor, resulting in less than optimum hydraulic conditions for the drill bit or other downhole drilling tools installed below the downhole drilling motor.

### SUMMARY

There is provided a flow bearing which includes a first tubular body and a second tubular body. The first tubular body has a first outer surface and a first inner surface defining a first bore. A first bearing surface is positioned on the first inner surface. The second tubular body has a second outer surface and a second inner surface defining a second bore. A second bearing surface is positioned on the second outer surface. The second tubular body is concentrically disposed within the first bore of the first tubular body, with the first inner surface facing the second outer surface. The first bearing surface and the second bearing surface are engaged in close fitting relation and define a mud lubricated flow gap. A metering valve is positioned one of upstream or downstream of the flow gap to meter flow through the flow gap.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view, in section, of a bearing assembly used in a downhole motor assembly that has a flow bearing with a metering valve positioned downstream of a mud lubricated flow gap.

FIG. 2 is a detailed side elevation view, in section, of the bearing assembly of FIG. 1.

FIG. 3 is a side elevation view, in section, of a bearing assembly used in a downhole motor assembly that has a flow bearing with a metering valve positioned upstream of a mud lubricated flow gap.

FIG. 4 is a detailed side elevation view, in section, of the bearing assembly of FIG. 2.

FIG. 5 is a detailed top plan view of a plug with a metering valve from the flow bearing illustrated in FIG. 1.

FIG. 6 is a section view taken along the line A-A of FIG. 5.

### DETAILED DESCRIPTION

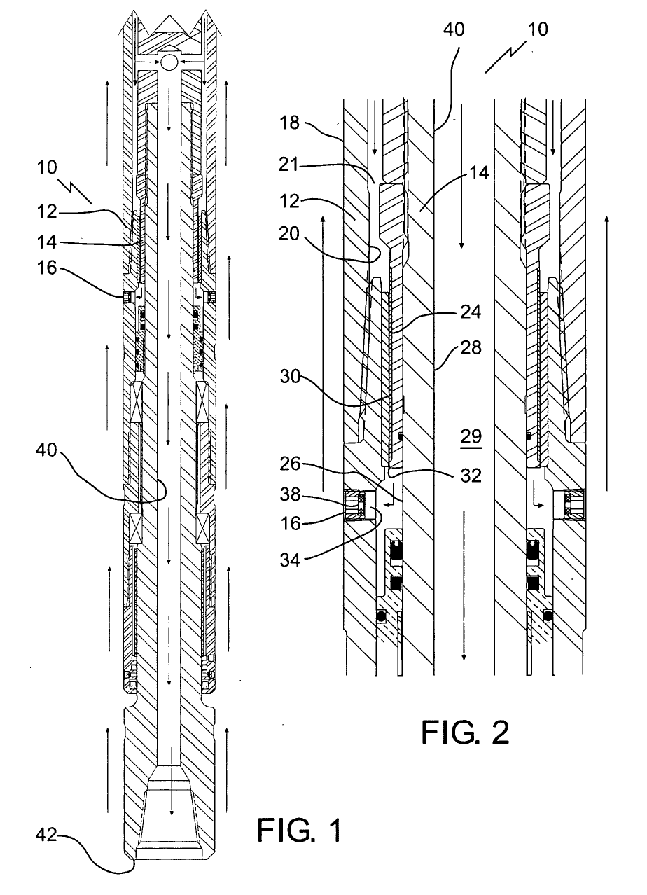

A flow bearing will now be described with reference to FIGS. 1 through 6. In FIGS. 1-4, arrows are used to indicate the flow of mud during operation. It should be understood that the lengths of the arrows in the drawings are not indicative of the speed or volume of flow. The arrows are provided for illustration purposes only.

Structure and Relationship of Parts:

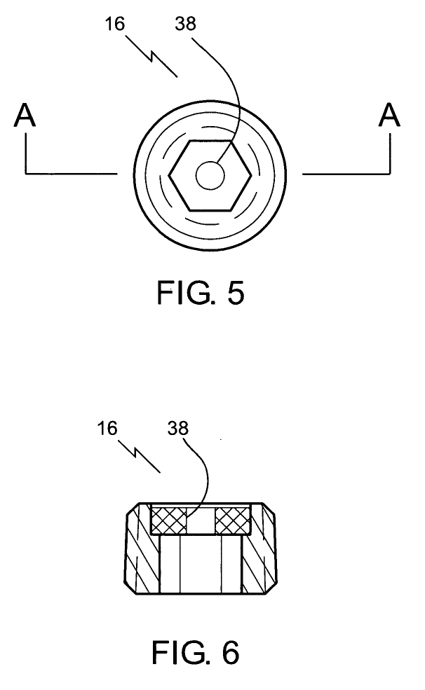

Referring to FIG. 1, flow bearing is incorporated into a downhole bearing sub, generally indicated by reference numeral 10. The flow bearing includes a first tubular body 12, a second tubular body 14, and at least one metering valve 16. Referring to FIG. 2, first tubular body 12 has a first outer surface 18 and a first inner surface 20. First inner surface 20 defines a first bore 21. Positioned on first inner surface 20 is a first bearing surface 24. Second tubular body 14 has a second outer surface 26 and a second inner surface 28. Second inner surface 28 defines a second bore 29. Positioned on second outer surface 26 is a second bearing surface 30. Second tubular body 14 is concentrically disposed within the first bore 21 of first tubular body 12, with first inner surface 20 facing second outer surface 26. In this position, first bearing surface 24 and second bearing surface 30 are engaged in close fitting relation and define a mud lubricated flow gap 32. In the example shown in FIG. 2, metering valve 16 is positioned downstream of flow gap 32 to meter flow through flow gap 32. Metering valve 16 may be positioned within an accessible flow passage 34 in fluid communication with first outer surface 18 of first tubular body 12. Metering valve 16 is externally accessible for removal and replacement from first outer surface 18 of first tubular body 12. Alternatively, metering valve 16 may be non-removable. Referring to FIGS. 5 and 6, in a preferred embodiment metering valve 16 is in the form of a screw in plug with a flow aperture 38. If it is desired to change the flow rate, metering valve 16 can be replaced with another metering valve 16 with a different sized flow aperture 38.

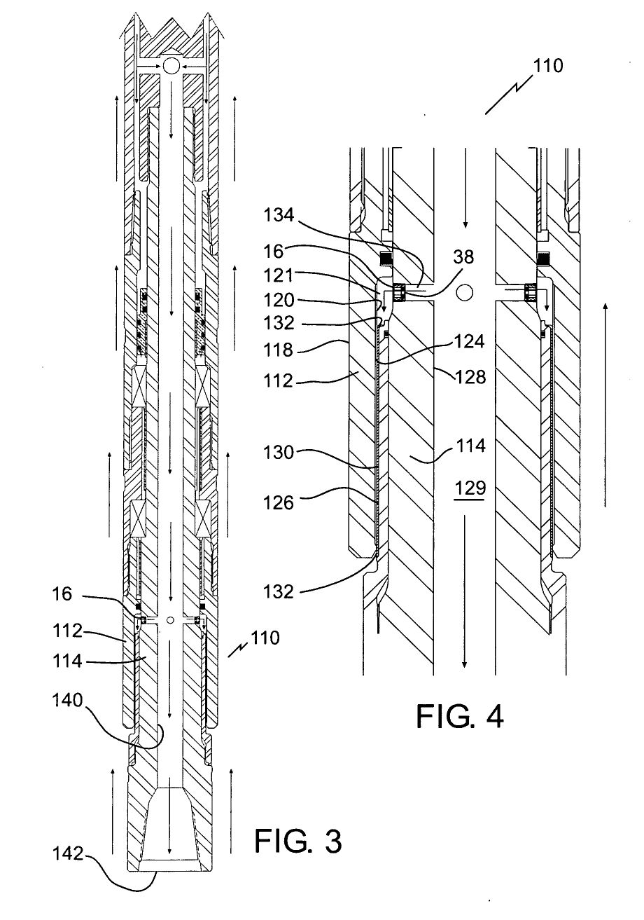

Referring to FIG. 3, a variation of a flow bearing is illustrated as being incorporated into a downhole bearing sub 110. Flow bearing has a first tubular body 112, a second tubular body 114, and at least one metering valve 16. Referring to FIG. 4, first tubular body 112 has a first outer surface 118 and a first inner surface 120. First inner surface 120 defines a first bore 121. Positioned on first inner surface 120 is a first bearing surface 124. Second tubular body 114 has a second outer surface 126 and a second inner surface 128. Second inner surface 128 defines a second bore 129. Positioned on second outer surface 126 is a second bearing surface 130. Second tubular body 114 is concentrically disposed within the first bore 121 of first tubular body 112, with first inner surface 120 facing second outer surface 126. In this position, first bearing surface 124 and second bearing surface 130 are engaged in close fitting relation and define a mud lubricated flow gap 132. In the example shown in FIG. 4, metering valve 16 is positioned upstream of flow gap 132 to meter flow through flow gap 132. Metering valve 16 is illustrated in this embodiment as non-removal. Alternatively, metering valve 16 may be accessible for removal and replacement. Metering valve 16 may be positioned within a flow passage 134 leading to flow gap 132 which is in fluid communication with second bore 129 of flow bearing 110.

Operation:

Referring to FIG. 1 during drilling, mud flow normally flows through second bore 29 of downhole bearing sub 10, and towards a drill bit end 42. After being used with a drill bit (not shown), the drilling mud carries drill cuttings and flows back up first outer surface 18 of downhole bearing sub 10 to the surface. Within downhole bearing sub 10, some of the mud flow is diverted to pass through flow gap 32 (shown in FIG. 2) and lubricate first bearing surface 24 and second bearing surface 30. Referring to FIG. 2, after passing through flow gap 32, mud flow passes along flow passage 34 through metering valve 16 to first outer surface 18 and back up to the surface. The size of flow aperture 38 in metering valve 16 determines the rate of flow. This ensures that, despite a wide range of factors that may vary during operation, such as mud flow pressure through second bore 29, the flow of mud through flow passage 34 will be relatively stable and controllable. Thus, flow aperture 38 can be configured so that the drill bit and downhole tools connected between the drilling motor and the drill bit (not shown) always have enough mud flow to work properly. If metering valve 16 were not used on flow passage 34, a high mud pressure flow through may result in excess mud flowing out of flow passage 34, would lead to the drill bit or downhole tools connected between the drilling motor and the drill bit being starved of fluid.

Referring to FIG. 4, the operation of this variation of the mud bearing is similar to that previously described. Mud flow is diverted to pass along flow passage 134, through metering valve 16, into flow gap 132 and out to first external surface 118. of downhole bearing sub 110. Mud flowing along first external surface 118 flows back up to the surface. Mud passing through flow gap 132 lubricates first bearing surface 124 and second bearing surface 130. The size of flow aperture 38 of metering valve 16 allows the volume of fluid flowing through metering valve 16 to be regulated.

Advantages:

With the present invention, metering valve 16 is selected to meter the flow through flow gaps 32 and 132 between the first bearing surface and the second bearing surface, in order to ensure that the flow does not exceed a pre-selected flow rate. Although an embodiment has been illustrated that shows the metering valve upstream of the flow gap, it is preferred that metering valve be located in an externally accessible plug downstream of the flow gap. When the metering valve is located on an externally accessible plug, it can be changed out. This enables a tool to be quickly adapted to meeting differing pressure parameters. It also enables the metering valve to be periodically inspected and replaced as wear occurs.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. A flow bearing, comprising:
a first tubular body having a first outer surface and a first inner surface defining a first bore;
a first bearing surface on the first inner surface;
a second tubular body having a second outer surface and a second inner surface defining a second bore;
a second bearing surface on the second outer surface;
the second tubular body being concentrically disposed within the first bore of the first tubular body, with the first inner surface facing the second outer surface, and with the first bearing surface and the second bearing surface engaged in close fitting relation and defining a mud lubricated flow gap; and
a metering valve being positioned one of upstream or downstream of the flow gap to meter flow through the flow gap.

2. The flow bearing of claim 1, wherein the metering valve is positioned downstream of the flow gap.

3. The flow bearing of claim 2, in which the metering valve is accessible for removal and replacement from the first outer surface of the first tubular body.

4-10. (canceled)

11. The flow bearing of claim 2, in which the metering valve is non-removable.

12. The flow bearing of claim 2, wherein the metering valve is in the form of a plug with a flow aperture.

13. The flow bearing of claim 1, wherein the metering valve is positioned upstream of the flow gap.

14. The flow bearing of claim 13, in which the metering valve is accessible for removal and replacement from the first outer surface of the first tubular body.

15. The flow bearing of claim 13, in which the metering valve is non-removable.

16. The flow bearing of claim 13, wherein the metering valve is in the form of a plug with a flow aperture.
